(19) United States
(12) Patent Application Publication
(10) Pub. No.: US 2006/0082550 A1
(43) Pub. Date: Apr. 20, 2006

(54) Multi-purpose joystick with input device

(76) Inventor: Jim Chin Tung Chen, Kaohsiung City (TW)

Correspondence Address: LEONG C LEI, PMB # 1008, 1867 YGNACIO VALLEY ROAD, WALNUT CREEK, CA, 94598, US

(21) Appl. No.: 10/968,124

(22) Filed: Oct. 20, 2004

(51) Int. Cl. G09G 5/08

(52) U.S. Cl. 345/161

(57) ABSTRACT

A multi-purpose joystick with input device includes joystick interface for TV game basic control keys and functional keys and built-in vibration function, keyboard interface related to a micro-USB keyboard for input with MARCO function keys to setup common terms for fast completion of input, IC circuit board to control functions of both interfaces, and signal line unit linked to game host to control and input characters; and 3D part of the joystick allowing shift to simulate mouse function.

### BACKGROUND OF THE INVENTION

(a) Technical Field of the Invention

The present invention is related to a multi-purpose joystick with input device, and more particularly to one that supports XBOX, PS2, GameCube, and PC TV games, and functions as a mouse and keyboard for PS2 on-line games.

(b) Description of the Prior Art

More new TV games including XBOX, PS, GameCube and PC games generally available in the market have been introduced for Internet users around the world, as TV game users demand more on the functionality of both of HW and SW to satisfy the excitement of games experience with other users. Wherein, with the exception of XBOX that has been provided with Ethernet, other types of games have to be equipped with a network adaptor for Internet access. However, these TV games though meet the needs of interconnection among game systems through the network, the summary joystick operation interface offers only the control of the game process and fails to meet the basic demands of communicating massive, and fast character inputs. That also frustrates the TV game design houses in the development of conversation by letters, or renders no choice for the user to use the virtual keyboard built in the game software. At present, though PS2 on-line game allows conversation through letters in conjunction with the keyboard, it is not convenient for the users to shift their hands between the joystick and the keyboard.

### SUMMARY OF THE INVENTION

The primary purpose of the present invention is to provide a multi-purpose joystick adapted with an input device. To achieve the purpose, the present invention is essentially comprised of a joystick interface, a keyboard interface, an IC circuit board and a signal line unit. The joystick interface contains basic operation keys including 3D Sticks, D-Pad, graphic keys, ear keys; functional keys including [START], [SELECT], and [MODE], and a built-in vibration function; the keyboard interface relates to a micro-USB keyboard available with [Fn] and [Cap] keys to input letters of upper and lower cases, numbers, and symbols, while allowing setup of common terms under the MARCO functional keys of [S1]˜[S4] for fast input; the control circuit built on the IC circuit board controls those functions provided on the joystick interface and the keyboard interface; and the signal line unit is capable of external connection with the game console for the control and character input. Furthermore, while allowing direct use of 3D functions, the 3D part of the joystick also shifts to provide mouse simulation functions.

While providing joystick functions to support game systems including XBOX, PS2, GameCube, and PC, the present invention further meets the easy character input in the process of the game to significantly improve easy conversation among Internet users to provide a multi-purpose joystick that is practical by integrated joystick, mouse and keyboard at reduced production cost.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts. Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view showing the appearance of the present invention.

FIG. 2 is a schematic view showing a preferred embodiment of the present invention.

FIG. 3 is a block chart showing the relation among key constructional members of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

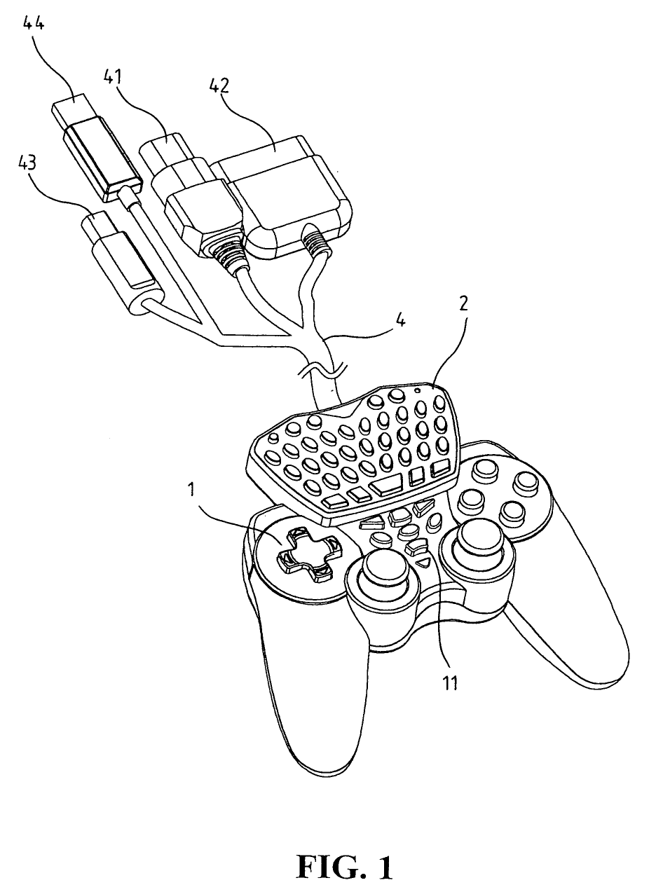

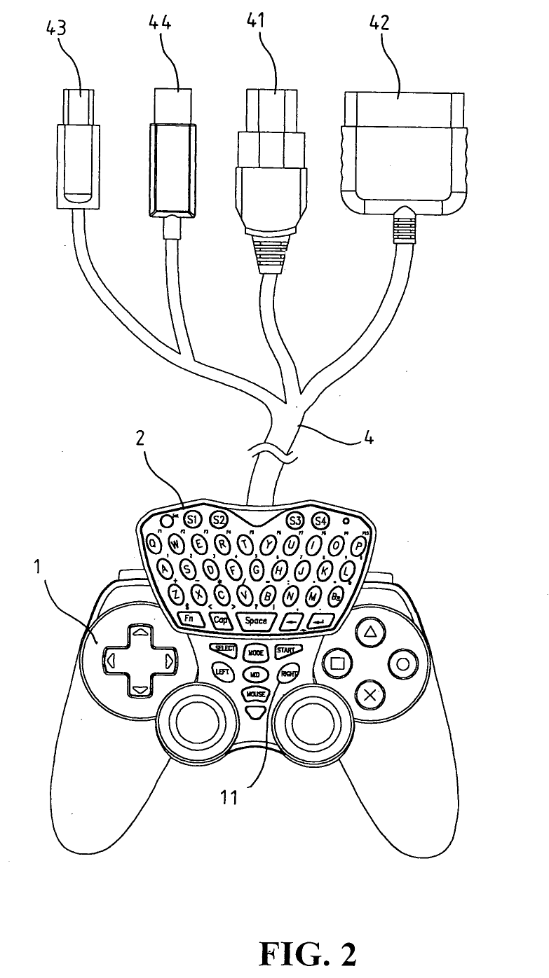

Referring to a preferred embodiment illustrated in FIGS. 1 and 2, the present invention is essentially comprised of a joystick interface (1), a keyboard interface (2), an IC circuit board (3) and a signal line unit (4). Wherein, the joystick interface (1) provided with keys for basic control and operation of a TV game joystick, such as 3Dsticks, D-Pad, graphic keys, ear keys and functional keys including [START], [SELECT], and [MODE] is adapted with a built-in vibration function. Furthermore, a key pad (11) corresponding to [LEFT], [MID], and [RIGHT] keys on a mouse is provided at where appropriately on the joystick for the joystick to shift to function as a mouse by pressing a [MOUSE] key to activate the mouse indexing functions available on the key pad (11) and 3D Sticks. The keyboard interface (2) relates to a micro-USB keyboard to input letters in upper and lower cases, numbers, and symbols in conjunction with [Fn] and [Cap] keys; and set up common terms (e.g., HI!) with MARCO functional keys of [S1]˜[S4] for fast input.

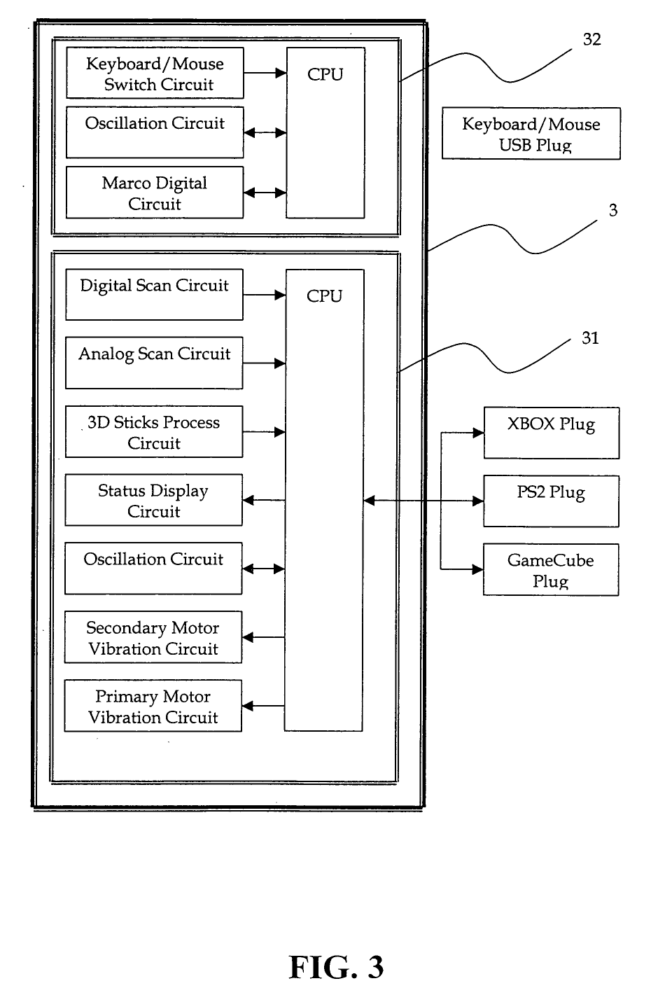

As illustrated in FIG. 3, the IC circuit board (3) includes control blocks respectively for the joystick interface (1) and the keyboard interface (2). A joystick control circuit (31) is externally connected to an XBOX joystick plug (41), a PS2 joystick plug (42), and a GameCube joystick plug (43); and a keyboard control circuit (32) is externally connected to a USB plug (44) to achieve the message link between the joystick and the console of the game system. Furthermore, both control circuits (31,32) feed back to each other 3D mobile data for the data to be converted into mouse indexing movement while the 3D mobile data are essentially supplied from the 3D Sticks process circuit.

The signal line unit (4) relates to one provided with plugs of various console plugs of game systems respectively adapted to XBOX, PS2, GameCube joystick plugs (41, 42, 43) and the USB plug (44) connected to the keyboard interface (2).

When assembled, the present invention allows the user to select a corresponding plug to plug in the console depending on the type of the TV game to access to the functions provided by the joystick interface (1); input characters with the keyboard interface (2) by inserting the USB plug (44) into the USB port of the console of the game system; shift to activate mouse functions through the [MOUSE] key for the 3D Sticks and the mouse key pad (11) to realize the mouse indexing function; and have only the USB plug (44) connected to a PC host to access to the keyboard functions provided by the keyboard interface (2).

The present invention while supporting the joystick functions of TV game systems including XBOX, PS2 and GameCube, permits the user easy input of characters in the course of playing the game to significantly upgrade the convenience of conversation via network; and offers advantages of lowered production cost in providing more practical functions with integrated functionalities of joystick, mouse and keyboard. It will be understood that each of the elements described above, or two or more together may also find a useful application in other types of methods differing from the type described above. While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A multi-purpose joystick adapted with input device is essentially comprised of a joystick interface, a keyboard interface, an IC circuit board, and a signal line unit; the joystick interface containing keys including 3D Sticks, D-Pad, graphic keys and ear keys of a TV game joystick for basic control and operation, functional keys including [START], [SELECT], and [MODE], and built-in vibration function; the keyboard interface related to a micro USB keyboard to input letters in upper and lower cases, numbers and symbols in conjunction with [Fn] and [Cap] keys; common terms being setup under MARCO functional keys of [S1]˜[S4] for fast input; functions provided by both of the joystick interface and the keyboard interface being controlled by the control circuit built on the IC circuit board; and the signal line unit externally connected to console of game system for control and character inputs.

2. The multi-purpose joystick adapted with input device of claim 1, wherein, a mouse pad containing keys corresponding to [LEFT], [MID], and [RIGHT] keys on a mouse is provided at where appropriately on the joystick interface; and the joystick is shifted to mouse functions as desired by pressing a [MOUSE] key to realize mouse indexing function in conjunction with 3D Sticks.

3. The multi-purpose joystick adapted with input device of claim 1, wherein, the IC circuit board is comprised of a joystick control circuit and a keyboard control circuit; both control circuits feeding back each other 3D mobile data; the data being converted into mouse indexing movement; and the 3D mobile data being essentially supplied from a 3D Sticks process circuit.

4. The multi-purpose joystick adapted with input device of claim 1, wherein, the signal line unit contains XBOX joystick plug, PS2 joystick plug, GameCube joystick plug, and USB plug.

5. The multi-purpose joystick adapted with input device of claim 3, wherein, the joystick control circuit is externally connected to XBOX joystick plug, PS2 joystick plug, and GameCube joystick plug; and the keyboard control circuit is externally connected to a USB plug for message linkage between the joystick and the console of a game system.
